(19) United States
(12) Patent Application Publication
(10) Pub. No.: US 2011/0316691 A1
(43) Pub. Date: Dec. 29, 2011

(54) FLAT-HIERARCHY SYSTEM FOR CONDITION-BASED MONITORING OF DISTRIBUTED EQUIPMENT

(76) Inventors: Brian Pepin, Oakland, CA (US); R. Aaron Falk, Newcastle, WA (US); Tram Pham, Renton, WA (US); Anthony J. Simon, Seattle, WA (US); Marc Ramme, Lynnwood, WA (US)

(21) Appl. No.: 13/100,993

(22) Filed: May 4, 2011

Related U.S. Application Data
(60) Provisional application No. 61/358,139, filed on Jun. 24, 2010.

(51) Int. Cl. G08B 1/08

(52) U.S. Cl. 340/539.1

(57) ABSTRACT

Systems and methods for monitoring the condition of equipment in a manufacturing plant or other facility. A computing node is attached to each piece of equipment under consideration. Each node gathers relevant information from the machine using sensors and is capable of determining the condition of the machine from a preexisting set of possible conditions, using only the information obtained from the sensors. Each node is thus entirely self-sufficient, in that it requires no interaction with a global controller or with other nodes in order to make a decision about the condition of the equipment, and does not necessarily require any information about the past history of the equipment. The nodes are capable of communicating the condition of their corresponding equipment to key maintenance or other personnel, potentially via a wireless network to a convenient wireless-capable device such as a cellular phone or laptop.

### PRIORITY CLAIM

This application claims priority to provisional patent application Ser. No. 61/358,139, filed Jun. 24, 2010 and is incorporated herein by reference.

### BACKGROUND OF THE INVENTION

Electrical motors are a fundamental part of the manufacturing environment, powering pumps, fans, air compressors, conveyor belts, and a wide array of other integral equipment. If a motor powering a given machine fails unexpectedly, the corresponding machine is also likely to fail, often resulting in costly unplanned downtime. In order to avoid unplanned downtime, maintenance staff in manufacturing facilities may conduct preventive maintenance, servicing every piece of equipment on a fixed schedule often enough to ensure unplanned downtime is maintained at a certain minimum level. This is also very costly, as the majority of service in a preventive maintenance scenario is not required. A better solution is to somehow collect information about the operating condition of the electric motors in a given facility and, based on this information, decide which motors need servicing. This kind of maintenance is called condition-based maintenance, and is much more efficient than preventive maintenance programs.

There are several systems in the prior art that have been developed to attempt to facilitate condition-based maintenance of electric motors. Currently, such systems fall into two main categories. The first category is a system in which a sensor node (with or without some signal-conditioning electronics) is mounted to a motor and a portable computer device is used to individually interact with each sensor node, possibly doing some more advance data processing. U.S. Pat. No. 7,606,673 uses a complex method for analyzing mean-time-to-failure of bearings based on data from such sensor nodes, where U.S. Pat. Nos. 5,726,911, 5,852,351, and 6,138,078 use a much wider array of sensor data to determine the motor state in more detail. U.S. Pat. No. 5,189,350 shows the simplest possible implementation, in which a threshold is set for a temperature sensor that indicates hazardous operation, and the sensor is communicated with via a generic data link. All such systems suffer from the same problems, namely that it takes too much time for maintenance personnel to individually check each motor's data, making the operation of the system overly costly. Additionally, many motors are located in difficult to reach areas making frequent manual data collection inconvenient, and use of the data collection systems often requires costly training to use effectively. As such, these types of systems are not viable candidates for enabling condition-based maintenance of electric motors systems.

The second type of system wirelessly transmits raw sensor data or lightly-processed sensor data from sensors placed on motors of interest back to a central computer for processing. This central computer is required because the algorithms used to determine motor condition are relatively complex. U.S. Pat. Nos. 6,199,018 and 7,346,475 use machine-learning based algorithms that rely on collecting and storing a large amount of baseline motor data. U.S. Pat. Nos. 6,014,598 and 5,519,337 rely on complex electromechanical models of the motor to make decisions. In the simplest implementations, U.S. Pat. Nos. 6,262,550 and 6,484,109 simply transmit data back to a central database where it is collected and stored for future use by another program. U.S. Pat. No. 6,529,135 at least provides methods for generating less complex warning signals, but is not implemented as part of a larger low-cost, low power wireless network. Due to rampant electromagnetic interference, multipath fading, and other difficulties transmitting the relatively complex data that all of these systems require through an industrial environment is extremely costly, and as such makes such systems prohibitively expensive for most applications.

### SUMMARY OF THE INVENTION

The present invention provides systems and methods for monitoring the condition of equipment in a manufacturing plant or other facility, whereby a computing node is attached to each piece of equipment under consideration. Each node is “intelligent” in the sense that it can gather relevant information from the machine using sensors and is capable of determining the condition of the machine from a preexisting set of possible conditions, using only the information obtained from the sensors. Each node is thus entirely self-sufficient, in that it requires no interaction with a global controller or with other nodes in order to make a decision about the condition of the equipment, and does not necessarily require any information about the past history of the equipment. The nodes are capable of communicating the condition of their corresponding equipment to key maintenance or other personnel, potentially via a wireless network to a convenient wireless-capable device such as a cellular phone or laptop. Because no transmission of raw data is required, only the transmission of condition-based warnings, the power and complexity of such a wireless transmission system are greatly reduced compared to condition-based monitoring systems in the prior art.

In the present invention, the monitoring system is truly distributed and all necessary processing is done at the individual nodes themselves. This allows for a greatly reduced need for data transmission between nodes and from nodes to other peripheral devices (such as the cell phone of the plant manager). This, in turn, lowers the cost of the overall system substantially.

### BRIEF DESCRIPTION OF THE DRAWINGS

Preferred and alternative examples of the present invention are described in detail below with reference to the following drawings:

FIG. 1 is a schematic diagram of an exemplary system formed in accordance with an embodiment of the present invention;

FIG. 2 is a block diagram of a component of the system shown in FIG. 1;

FIG. 3 is a flow diagram of an exemplary process performed by components of the system shown in FIG. 1;

FIGS. 4 and 5 show exemplary user interfaces presented on component of the system shown in FIG. 1;

FIGS. 6a-d illustrate sensor results according to embodiments of the present invention; and

FIG. 7 is a schematic diagram of an exemplary system formed in accordance with an embodiment of the present invention.

### DETAILED DESCRIPTION OF THE PREFERRED EMBODIMENT

The present invention concerns a distributed motor monitoring system (DMMS), one that requires no external analysis of data by a central controller or computer. An exemplary system includes several nodes, each node attached to a motor of interest. Each node includes, among other things, sensors to detect vibration, temperature, voltage, current, or other waveforms produced by phenomena in the motor that are indicative of its operating condition and a microcontroller with processing capability to implement simple signal processing algorithms, which determine from the sensor data if the motor is operating in a dangerous or inefficient state. The system alerts personnel to any dangerous operating conditions determined by the microcontroller(s).

The distributed motor monitoring system that is the subject of the present invention fundamentally includes a collection of sensor and computing nodes. Each node determines if a common problem, such as overheating, bearing failure, or a misaligned motor shaft, is causing the motor to operate in a dangerous or inefficient manner. The node also, upon detecting such dangerous or inefficient operation, alerts key plant personnel via a wired or wireless connection to any array of devices, including warning lights, personal computers, laptops, cellular phones and pagers, or an existing centralized control system in the plant. By generating and transmitting only “warnings”, as opposed to complex physical data, the present invention of a distributed motor monitoring system (DMMS) is constructed and implemented at a greatly reduced complexity and cost compared to the current state-of-the-art in motor monitoring, allowing more manufacturers to be able to reap the energy efficiency and predictive maintenance benefits imparted by motor monitoring.

The range of motor problems detectable by the sensor nodes is a function of the sensors and processing power of the microcontroller. In one embodiment, the system detects the common problems of worn or broken bearings, misaligned motor shaft, and overheating due to insulation or fan failure. Additionally or alternatively, the node device is configured with a battery-life monitor, a counter indicating total motor failures or repairs, and any range of other indicators. In one embodiment, the indicators include a light-emitting diode (LED)-type display on the node itself, a wired connection from the node to an indicator relay or a wirelessly transmitted warning signal to a peripheral device, such as the plant manager's cell phone.

### Distributed Architecture

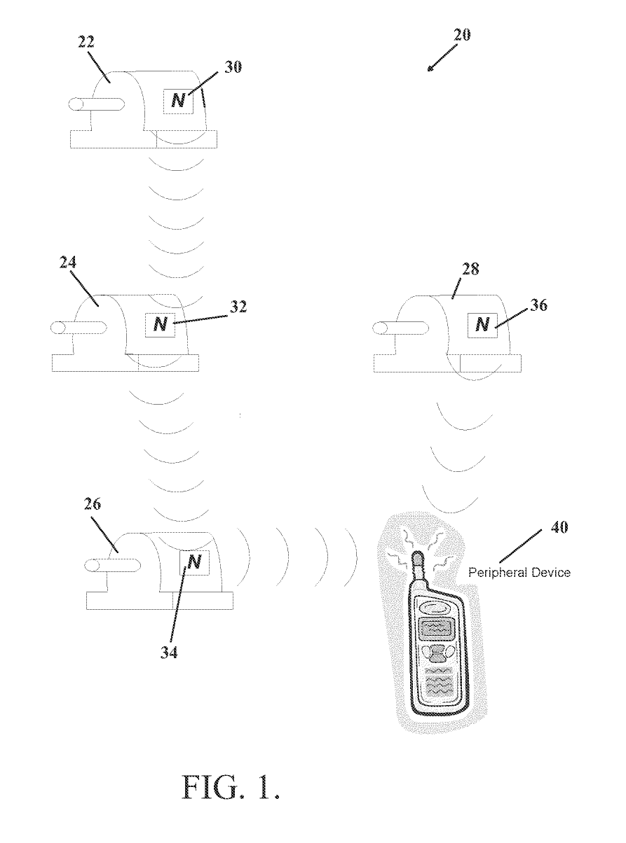

An exemplary architecture for the present invention of a DMMS is shown in FIG. 1. As shown in FIG. 1, an exemplary manufacturing plant 20 includes a plurality of electric motors 22-28. Each of the electric motors 22-28 includes a node device 30-36. The plant 20 also includes a peripheral device 40, such as a plant manager's cellular phone. The node devices 30-36 communicate wirelessly with the peripheral device 40. The peripheral device 40 may be any portable computer-based device, such as a smartphone, a personal data assistant, a laptop computer, or a tablet computer. The wireless communication can be done, for example, using conventional wireless technologies, such as HART, Zigbee, or Bluetooth®. The DMMS is the combination of the noted devices 30-36 and the peripheral device(s) 40.

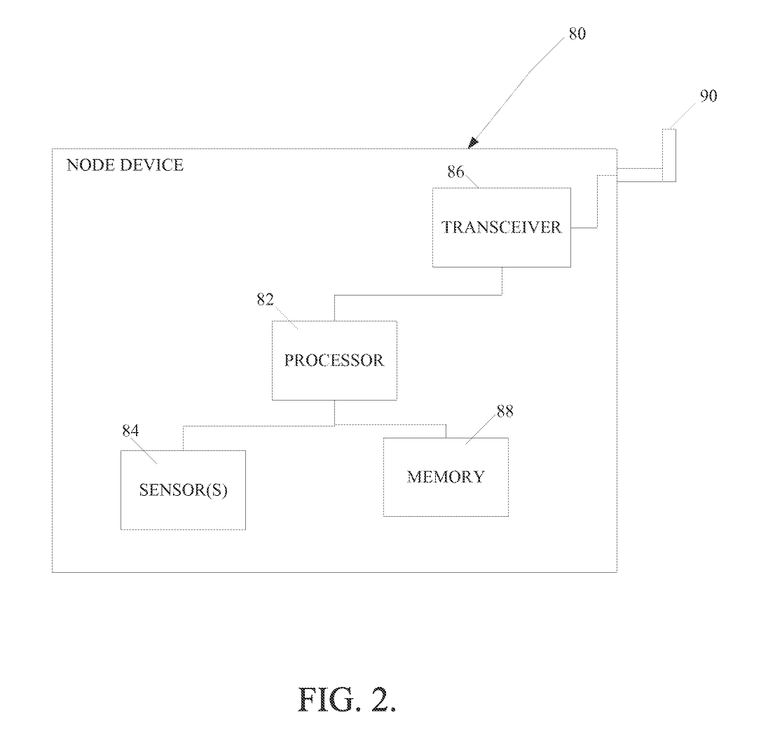

FIG. 2 shows an exemplary node device 80. The node device 80 includes a processor 82, a sensor(s) 84, memory 88, and an antenna 90 attached to a transceiver 86. The processor 82 is in signal communication with the sensor(s) 84, the memory 88 and the transceiver 86.

Referring back to FIG. 1, memory 88 and the node devices 30-36 determine if the motor is operating dangerously or inefficiently based on input received from their respective sensors.

The first motor 22 is far away from the peripheral device 40, and so its signal is relayed to the peripheral device 40 via other node devices 32, 34, thus creating a network. The node devices 34, 36 of the third and fourth motors 28, 30 can transmit directly to the peripheral device 40 because the third and fourth motors 28, 30 are within a communication distance of the peripheral device 40. The individual node devices 30-36 need only transmit at power levels high enough to reach a nearby node (not all the way to the peripheral device 40. This allows the transmitter (the transceiver 86) to use less power and be sized to operate efficiently, thus conserving node energy.

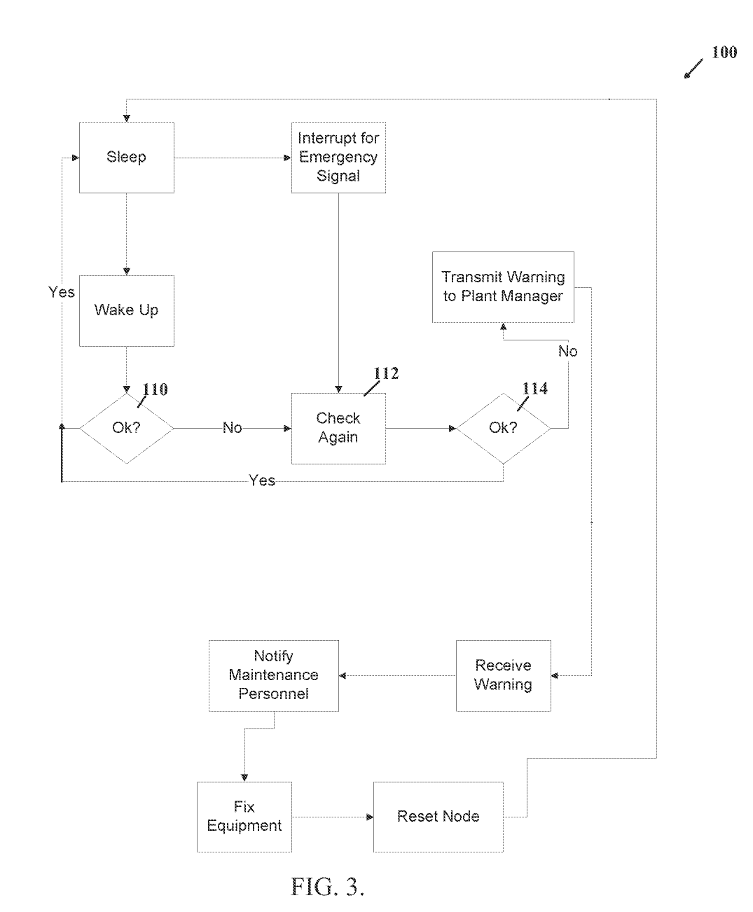

A high-level flow diagram of an exemplary process 100 is shown in FIG. 3. The node device begins in “sleep” mode that is a low-power standby state, which conserves power. Periodically, the node device “wakes up” to check the output of the sensors, to determine if the respective motor is operating safely, and to potentially store information in memory. Additionally, the sleep mode could be “interrupted” by some sensor signal that is predetermined by the processor 82 to be indicative of especially dangerous motor operation, for example, excessive vibration at a given frequency. In either case, if, at a decision block 110, the processor 82 determines nothing dangerous or inefficient is occurring, the node device returns to sleep mode. Alternatively, if the node device determines something is operating dangerously or inefficiently at decision block 110, the processor 82 checks again, at blocks 112 and 114 to verify the behavior, and, if verified, sends a “warning notice” to the peripheral device(s) used by key maintenance personnel. The plant manager, upon receiving the warning message at the peripheral device, can then contact maintenance personnel in charge of the specific equipment, who can then repair the equipment quickly and efficiently, the general problem already having been identified (i.e., worn bearing, misaligned shaft, etc.). When finished, the maintenance personnel return the node device to the “sleep” state, ready to detect the next motor fault.

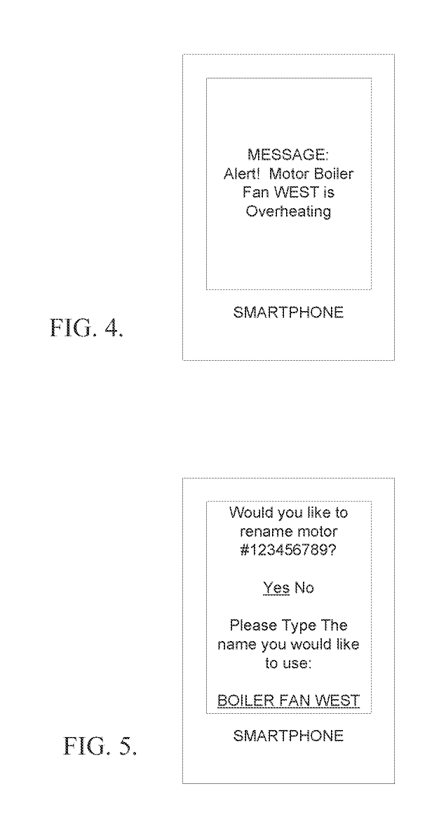

The warning transmitted from the node device lets the plant manager know exactly which piece of equipment is in trouble. An example of this is shown in FIG. 4.

As shown in FIG. 5, the plant manager uses a user interface on the peripheral device to assign a name to the node device (“Boiler Fan WEST”) that corresponds to the motor, as identified by a unique identifier received from the node device, on which the node device is attached. The assigned data is stored in the peripheral device and can be transferred securely to other devices as necessary. If the assigned name is adequately descriptive, maintenance personnel will have no problem locating the equipment in trouble and repairing it without delay.

### Minimum Power Operation

Minimum power operation of the DMMS (and of each individual node) is achieved by using minimum transmission of data and minimum processing time.

Minimum Transmission of Data: Because each node is entirely self-sufficient with regard to its ability to determine a problem or fault in the piece of equipment it is attached to, there is no need for any kind of regular transmission between node devices or from node devices to a global controller. Communication is generally limited to the following scenarios:
a. A faulty condition is detected in the equipment
b. The battery powering the node device is below a threshold value
c. When the node device receives a faulty condition signal from another node device, and must relay it to a final device.

In all these cases, the data being transmitted is a simple condition signal indicating a problem with the motor. This is enabled by the fact that the node device itself is capable of doing the necessary data processing to determine a limited range of common motor problems. Because the present invention does not have to transmit complex physical data, such as vibration data, to a global processor or controller for analysis, the data transmission can be at a much lower power and is less sensitive to corruption by the many electromagnetic signals common to an industrial environment. For example, consider a simple version of the present invention where the sensor input includes two accelerometers each with two axes of measurement, where each data set corresponds to 256 consecutive samples from each axis for a total of 1024 samples. Further assume that each sample has at least 16 bits of precision, resulting in a total of 16,384 bits for each measurement. Current systems for wireless motor monitoring need to transmit all this information back to a central computer or other global controller for processing. In contrast, the present invention does the necessary processing of the accelerometer measurements locally to determine the operating condition of the motor. In this example, the determined operating condition of the motor is identified by a 3-bit state value (representing a total of 8 possible states, including shaft misalignment, overheating, bearing failure, etc.). The 3-bit state value is what the node device transmits. Assuming both transmissions require a similar level of redundancy and allowing for certain energy costs in the data transmission that are independent of the number of the bits transmitted, in this scenario the present invention easily achieves more than a 1000× power advantage in data transmission over current systems for wireless motor monitoring.

Minimum Processing: The current state of the art in condition-based monitoring relies primarily on storing large amounts of “baseline” information from a healthy motor, and then comparing that data to current operating data using a least-squares-type of comparison algorithm. Besides requiring a healthy motor to start out, this approach is computationally intensive and often requires additional communication between the sensor nodes and a global processor. In contrast, the present invention uses signals-processing algorithms that are computationally efficient and capable of determining a fault or problem in the motor, based only on the present state of the machine. These algorithms take advantage of the massive amount of standardization in the industrial electric motor industry, and will be outlined in the following section.

### Self-Sufficient Node Intelligence

The vast majority of electric motors between 5 hp and 150 hp have a standardized designs which are designated by National Electrical Manufacturers Association (NEMA) enclosures and frame types, where all motors with this design suffer from the same general problems such as bearing failure, shaft misalignment, and overheating due to insulation failure or fan failure. The present invention takes advantage of this fact by implementing a small amount of signal processing at each individual node device, which, although modest compared to the computing power of a personal computer, is nevertheless enough to detect the most common problems or faults in a given motor.

The necessary signal processing can be accomplished with a variety of algorithms, including the following two (note that none of these necessarily require a “base-lining” period in which data is first collected by a healthy motor).

Spectral Enveloping (Time-Varying Fast Fourier Transform (FFT)) and FFT

The well-known Fast Fourier Transform (FFT) is an energy efficient algorithm for transferring the time-domain data collected by the nodes of the present invention into the frequency domain. The technique of Spectral Enveloping builds on the FFT algorithm by breaking the original time-domain data into smaller sections and extracting information from how the FFTs for each of these individual sections differ from one another (and possibly comparing to the FFT for the entire data set).

The manner in which the spectral characteristics of a rotating machine's vibration, temperature, and electrical characteristics change over relatively short periods of time can be indicative of certain operation conditions. This strategy can be used to detect a sudden failure in a bearing due to the appearance of new high-frequency peaks.

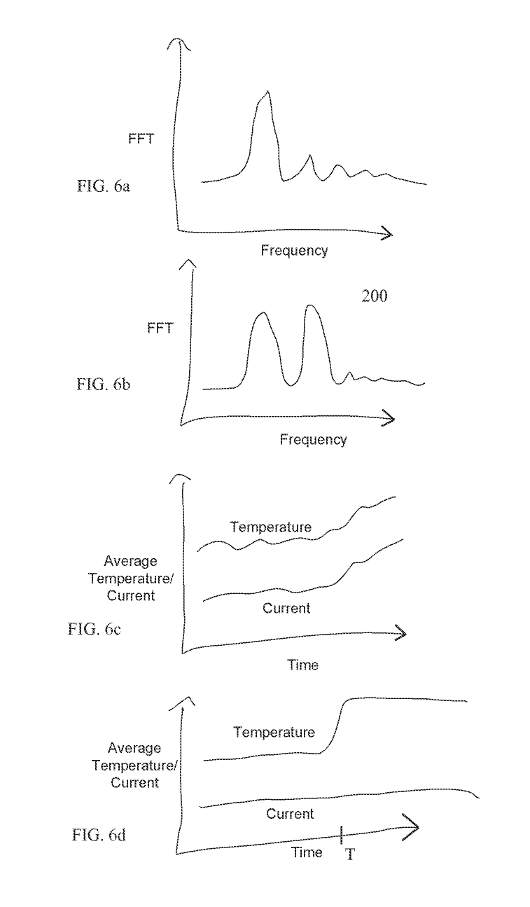

Data from a single FFT data set can also be used. For example, from an FFT of a data set of vibration data taken from an accelerometer attached to an appropriate part of an electric motor, a misaligned motor shaft on said motor can be detected by the difference in relative magnitude between two peaks in the vibration spectrum, the first peak representing the fundamental component of vibration due to the normal operation of the motor, the second peak representing a large second harmonic caused by misalignment of the motor shaft. See FIGS. 6A, B.

Time-Varying Averages

For example, take a node device with two sensors: a temperature sensor indicating the winding temperature of the motor and a flux sensor indicative of the motor's load. Overheating of the winding can be determined by comparing the time-varying averages of the two sensor outputs. In particular, if the time-varying average of the temperature sensor should increase without a corresponding increase in the time-varying average of the load sensor, overheating is likely. See FIGS. 6C, D for a graphical example.

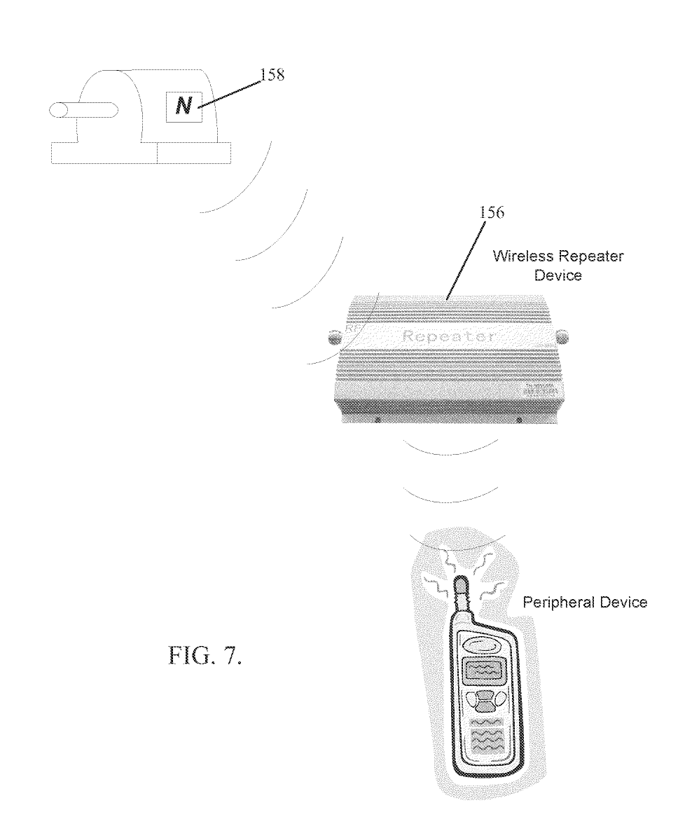

An alternative system 150 is shown in FIG. 7. The system 150 uses repeaters device 156 to retransmit a signal received from a proximate node device(s) 158. The repeater device 156 may be located conveniently near a power source, thereby providing a signal with a high enough energy level to be detected by the end-user device 160.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method comprising:
at a processing device located at a node device, the node device being attached to a dynamic piece of equipment in a facility,
receiving at least one signal from at least one sensor configured to sense at least one condition of the dynamic piece of equipment;
generating a warning signal if the received signal indicates an error condition exists; and
retrieving information associated with the dynamic piece of equipment from a memory device located at the node device;
from a transmitter located at the node device,
wirelessly transmitting the warning signal and the retrieved dynamic piece of equipment information; and
at a peripheral computer-based device,
receiving the wirelessly transmitting warning signal and the dynamic piece of equipment information; and
presenting warning and dynamic piece of equipment information based on the received warning signal and the dynamic piece of equipment information.

2. The method of claim 1, wherein generating the warning signal comprises:
analyzing the received signal from the at least one sensor; and
determining if the error condition exists based on the analysis.

3. The method of claim 2, wherein receiving at least one signal comprises:
receiving at least one of a vibration signal, a temperature signal, a voltage signal, or a current signal.

4. The method of claim 3, wherein analyzing comprises determining spectral characteristics of the received at least one of a vibration signal, a temperature signal, a voltage signal, or a current signal,
wherein determining if the error condition exists comprises determining if the spectral characteristics indicate that the error condition exists.

5. The method of claim 3, wherein receiving at least one of the vibration signal, the temperature signal, the voltage signal, or the current signal comprises receiving two signals from different sensors,
wherein analyzing comprises comparing time-varying averages of the two signals,
wherein determining if the error condition exists comprises determining if the error condition exists based on the comparison.

6. The method of claim 1, further comprising:
at the processing device, generating a user interface configured to receive a user entry of a name for the dynamic piece of equipment associated with the node device.

7. The method of claim 1, wherein the dynamic piece of equipment comprises a motor.

8. A monitoring system comprising:
a plurality of node devices, each of the plurality of node devices being associated with a dynamic piece of equipment of a plurality of pieces of equipment at a facility, each of the plurality of node devices comprising:
at least one sensor;
a memory device;
a wireless communication component; and
a processing device in signal communication with the at least one sensor, the memory device, and the wireless communication component, the processing device configured to:
receive at least one signal from at least one sensor configured to sense at least one condition of the dynamic piece of equipment;
generate a warning signal if the received signal indicates an error condition exists; and
retrieve information associated with the dynamic piece of equipment from a memory device located at the node device,
wherein the wirelessly communication component is configured to transmit the warning signal and the retrieved dynamic piece of equipment information; and
a peripheral computer-based device configured to receive the wirelessly transmitting warning signal and the dynamic piece of equipment information and present warning and dynamic piece of equipment information based on the received warning signal and the dynamic piece of equipment information.

9. The system of claim 8, wherein the processing device generates the warning signal by analyzing the received signal from the at least one sensor and determining if the error condition exists based on the analysis.

10. The system of claim 9, wherein the at least one sensor comprises at least one of a vibration sensor, a temperature sensor, a voltage sensor, or a current sensor.

11. The system of claim 10, wherein the processing device analyzes by determining spectral characteristics of outputs of the at least one sensor,
wherein the processing device determines if the error condition exists by determining if the spectral characteristics indicate that the error condition exists.

12. The system of claim 10, wherein the at least one sensor comprises two sensors,
wherein the processing device analyzes by comparing time-varying averages of the two signals,
wherein the processing device determines if the error condition exists further based on the comparison.

13. The system of claim 8, wherein the processing device is further configured to generate a user interface configured to receive a user entry of a name for the dynamic piece of equipment associated with the node device.

14. The system of claim 8, wherein the dynamic piece of equipment comprises a motor.
